(19) United States
(12) Patent Application Publication
(10) Pub. No.: US 2024/0338529 A1
(43) Pub. Date: Oct. 10, 2024

(54) NATURAL LANGUAGE INTERFACE FOR MONITORING OF MANUFACTURING PROCESSES

(71) Applicant: Sight Machine, Inc., San Francisco, CA (US)

(72) Inventors: Kurtis Alan DEMAAGD, Chelsea, MI (US); Nathan OOSTENDORP, Ann Arbor, MI (US); Alexandria Kay PAWLIK, Ann Arbor, MI (US); Andrew HOME, San Francisco, CA (US)

(21) Appl. No.: 18/627,082

(22) Filed: Apr. 4, 2024

Related U.S. Application Data
(60) Provisional application No. 63/457,083, filed on Apr. 4, 2023.

(51) Int. Cl. G06F 40/35; G06F 16/332; G06Q 50/04; H04L 51/02

(52) U.S. Cl. CPC G06F 40/35; G06F 16/3329; G06Q 50/04; H04L 51/02

(57) ABSTRACT

Systems and methods are described for generating and implementing a computer-based user interface allowing users natural language interactions with manufacturing site data. Data collected from a manufacturing site are synthesized into a form compatible with an artificial intelligence chatbot. In some embodiments, a number of grammatically complete textual fact sentences are generated, summarizing the synthesized data and any desired context in natural language form. A computer-based user interface may be provided, allowing users to enter natural language queries requesting information on the manufacturing site. Entered queries are then forwarded to an artificial intelligence chatbot along with generated fact sentences containing synthesized data from the manufacturing site and relevant context, which allows the chatbot to use the fact sentences to formulate natural language responses to the queries.

### CROSS-REFERENCE TO RELATED APPLICATIONS

This application claims priority to U.S. Provisional Patent Application Ser. No. 63/457,083, “NATURAL LANGUAGE INTERFACE FOR MONITORING OF MANUFACTURING PROCESSES,” filed on Apr. 4, 2023, the entire content of which is hereby incorporated by reference in its entirety and for all purposes.

### FIELD

The present disclosure relates generally to natural language interfaces. More specifically, the present disclosure relates to natural language interfaces for monitoring of manufacturing processes.

### SUMMARY

Contemporary manufacturing facilities or sites often execute multiple complex, extensive, and heterogeneous processes. Monitoring and maintaining such processes often entail collection and synthesis of significant amounts of data. For example, many sensors may be placed at multiple locations along a production line, to monitor many different aspects of line production. Data from these sensors and other data sources is key for detecting problems as they occur, and for determining the causes of inefficiencies and underperformance. The sheer amount of such data, and the speed by which it must be synthesized and analyzed, can create difficulties in producing interfaces that display data in a form that is easy for humans to understand.

Systems and methods of embodiments of the disclosure attempt to address these difficulties by synthesizing data collected from a manufacturing site into a form compatible with an artificial intelligence chatbot, and employing a computer-based interface that provides the synthesized data to the chatbot. The data may be synthesized and presented to the chatbot in a natural language form such as grammatically complete text sentences, and both the interface and chatbot may each accept natural language queries and return natural language responses. In particular, when the chatbot is a natural language chatbot operating according to, e.g., one or more large language models, the interface may accept user queries and send these queries to the chatbot along with the synthesized manufacturing data in natural language sentence form. The chatbot may then operate on the natural language form of the synthesized manufacturing data, to determine a response to the query. This response may then be returned to the user via the interface. As the chatbot is a natural language chatbot, converting manufacturing data to a natural language sentence-based format allows the chatbot to more readily accept and process the manufacturing data, yielding better and more accurate responses. Accordingly, embodiments of the disclosure produce an interface that allows users to more intuitively and easily view and understand manufacturing process data, which results in better operator decisions and improved manufacturing site performance.

In some embodiments of the disclosure, a computer-implemented method for monitoring manufacturing may include receiving data output by data sources of a manufacturing site, and determining, from the received data, one or more predictors having correlations with one or more performance metrics characterizing a process carried out at the manufacturing site. Subsequently, the process may include generating one or more textual sentences describing the one or more predictors and the corresponding correlations, and generating a computer-based interface for receiving a query requesting information describing the manufacturing site. A query may then be received and, in response, the query and the generated one or more textual sentences may be transmitted to a conversational agent. The process may then include receiving, from the conversational agent, a response to the transmitted query, and displaying the response on the computer-based interface.

Other aspects and advantages of embodiments of the disclosure will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 is a schematic diagram illustrating a system for implementing a natural language interface for monitoring of manufacturing processes in accordance with embodiments of the disclosure;

FIG. 2 is a block diagram conceptually illustrating exemplary operation of the system of FIG. 1 in accordance with embodiments of the disclosure;

FIG. 3 is a generalized embodiment of an illustrative data synthesis computing device constructed for use according to embodiments of the disclosure;

FIG. 4 is a flow chart depicting an exemplary method of implementing a natural language interface for monitoring of manufacturing processes in accordance with embodiments of the disclosure; and

FIGS. 5A-5J illustrate exemplary user interfaces and their use in accordance with embodiments of the disclosure.

### DETAILED DESCRIPTION

Certain details are set forth below to provide a sufficient understanding of various embodiments of the disclosure. However, it will be clear to one skilled in the art that embodiments of the disclosure may be practiced without one or more of these particular details, or with other details. Moreover, the particular embodiments of the present disclosure described herein are provided by way of example and should not be used to limit the scope of the disclosure to these particular embodiments. In other instances, hardware components, network architectures, and/or software operations have not been shown in detail in order to avoid unnecessarily obscuring the disclosure.

In some embodiments of the disclosure, systems and methods are described for generating and implementing a computer-based user interface allowing users natural language interactions with manufacturing site data. Data collected from a manufacturing site are synthesized into a form compatible with an artificial intelligence chatbot. In some embodiments, a number of grammatically complete textual fact sentences are generated, summarizing the synthesized data and any desired context in natural language form. A computer-based user interface may be provided, allowing users to enter natural language queries requesting information on the manufacturing site. Entered queries are then forwarded to an artificial intelligence chatbot along with generated fact sentences containing synthesized data from the manufacturing site and relevant context, which allows the chatbot to use the fact sentences to formulate natural language responses to the queries. Responses can then be returned to the user interface for display to the user. In this manner, systems and methods of embodiments of the disclosure implement a more effective, intuitive and easy to use interface that allows a user to enter natural language queries requesting information on a manufacturing site, and to receive more accurate natural language responses to those queries. More specifically, it has been found that some current chatbots and other interactive artificial intelligence agents do not provide accurate answers to some queries when they are only provided with numerical data. In some embodiments then, data are synthesized and arranged in grammatically complete and textual fact sentence form instead, so as to be presented to artificial intelligence agents in a natural language format containing a context for relevant data. Given this additional context, some artificial intelligence agents have been found to provide more accurate and robust responses to user queries.

Any desired performance metrics and variables influencing these metrics may be determined and placed in a form compatible with a natural language chatbot, e.g., fact sentences describing these metrics and variables in natural language form. Accordingly, natural language chatbots may more readily and accurately process the metrics and variables to formulate more accurate responses to user queries.

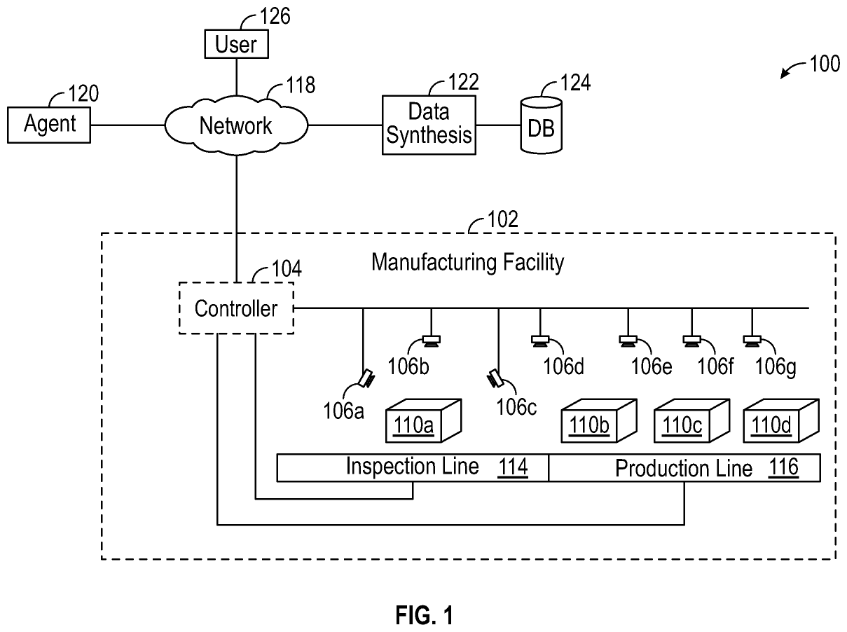

FIG. 1 is a schematic diagram illustrating a system for implementing a natural language interface for monitoring of manufacturing processes in accordance with embodiments of the disclosure. Here, an exemplary system 100 for remotely monitoring a manufacturing facility 102 is shown. The manufacturing facility 102 may include one or more controllers 104 in electronic communication with one or more sensors 106a-g via a data network 108. The sensors 106a-g may collect data from a plurality of machines, product stages, assembly lines and/or subassembly lines, or facility locations. For simplicity of illustration, FIG. 1 shows the plurality of sensors 106a-g monitoring a plurality of machines and/or product checkpoints, schematically represented as products 110a-d, at a production assembly line 112 and an inspection assembly line 114. It is noted that any number of products, production stages, machines, sensors, and wireless and/or wired communication channels may be contemplated.

In addition to data that are sensed by sensors 106a-g, factory data may include data generated by machines in the production assembly line 112 and/or the inspection assembly line 114. Factory data may also include data calculated by, or input into, system 100. For example, factory data may include operational parameters of production and/or inspection lines, e.g., a recipe a robot was scheduled to run or a trajectory that was calculated for a robot to follow.

The controller 104 at the manufacturing facility 102 is in electronic communication with a data synthesis computing device 122 that is in turn in electronic communication with a data storage 124. The controller 104 may be in communication with the data synthesis computing device 122 via an electronic communications network 118, which may be any electronic communications network such as the Internet. Data synthesis computing device 122 may be any electronic computing device capable of receiving data from sensors 106a-g and other data from controller 104, synthesizing the data in any desired manner, and communicating with agent 120, such as a server computer.

Data synthesis computer 122 may also be in electronic communication with an agent 120 and any number of user computers 126, each via network 118. User computers 126 may be any computing devices capable of allowing users to interact with a user interface, such as a desktop computer, a laptop computer, a mobile computing device such as a tablet computer or a cellular phone, or the like.

The sensors 106a-g may include analog and/or digital sensors, such as bio sensors, chemistry and/or composition sensors, current and/or power sensors, air quality sensors, gas sensors, Hall Effect sensors, lightness level sensors, optical sensors, pressure sensors, temperature sensors, ultrasonic sensors, proximity sensors, door status sensors, motion tracking sensors, humidity sensors, visible and infrared light sensors, cameras, and so on. For example, a door status sensor may detect an open and/or closed state of a door, in addition or alternative to auto-opening and/or auto-locking of the door. Cameras may capture images for visualizing and/or analyzing a particular factory and/or manufactured part. Such sensors may collect data that is further used individually and/or in combination to determine various environmental factors and/or assembly line operating statuses and/or conditions. For example, the sensor data may be utilized to determine if an assembly line is shut down and/or operating properly.

As shown in FIG. 1, the sensors 106a-g may send a signal to the controller 104 via data network 108, which may include one- or two-way wireless communications and/or physical wiring channels, WiFi, Bluetooth, and/or other radio frequencies. In some cases, data collected by the sensors may be stored at the databases 118-c provided on a cloud, such as a cloud server 116, that is accessible through the web and allows for remote data storage, backup, and/or processing. In some examples, the controller 104 includes one or more programmable logic controllers (PLCs), software, and/or microprocessors, which may collect, process, analyze, and/or present the data according to various methods described herein. The controller 104 may trigger one or more flags and/or notifications related to the monitored manufacturing and/or can automatically reconfigure one or more processes in an assembly line according to one or more optimization rules. For example, based on the collected sensor data, the controller 104 may not only report an underperforming machine but also automatically reconfigure one or more stages of the machine in an effort to reduce system downtime. In another aspect, automatically performing such adjustments may further increase safety by eliminating a need for human interaction with the machine. It is contemplated that any of the techniques disclosed herein may be performed by one or more controllers 104 and/or at the server 116. Embodiments of the disclosure contemplate use of any systems for monitoring of manufacturing facilities and analysis of resulting data. Some exemplary systems are described in U.S. Provisional Application No. 61/606,257 which was filed on Mar. 2, 2012 and bears the title “SYSTEM AND METHOD FOR REMOTE MANAGEMENT OF A MACHINE VISION ARRAY,” U.S. Provisional Application No. 62/402,835 which was filed on Sep. 30, 2016 and bears the title “SYSTEM AND METHOD FOR MONITORING MANUFACTURING,” U.S. patent application Ser. No. 13/783,107 which was filed on Mar. 1, 2013 and bears the title “MACHINE-VISION SYSTEM AND METHOD FOR REMOTE QUALITY INSPECTION OF A PRODUCT,” and U.S. patent application Ser. No. 15/723,016 which was filed on Oct. 2, 2017 and bears the title “SYSTEM AND METHOD FOR MONITORING MANUFACTURING,” each of which are hereby incorporated by reference in their entireties and for all purposes.

In an exemplary embodiment, the system 100 collects the production data at the controller 104 and sends the collected data to the data synthesis computer 122 which analyzes, synthesizes, and formats the data using various machine learning algorithms and other data conditioning and analysis techniques, generates a user interface for interaction with user computers 126, and presents user queries and synthesized formatted data to agent 120. Analytics performed on the manufacturing data may include transformations, calculations, and functions on raw data using models representing manufacturing processes and parts. Such manufacturing analytics applications provide insight on, for example, part quality, process performance, OEEdrill down, root cause analysis, anomaly detection, traceability, real-time SPC, preventive maintenance, and, predictive alerting, among others. In another aspect, the general manufacturer can map or otherwise correlate part data with certain parts, and/or machine data with certain machines that manufactured certain parts. For example, if the general manufacturer identifies a machine problem with a particular machine, the present systems and methods may identify which particular parts and/or overall products may have been equipped with the faulty product. Received data may be stored in database 124 for retrieval and analysis as desired. Synthesized data may also be formatted as desired, such as via conversion to natural language sentences. Such conversion may be performed in any desired manner, e.g., via natural language processing (NLP) methods including various machine learning algorithms and other data models.

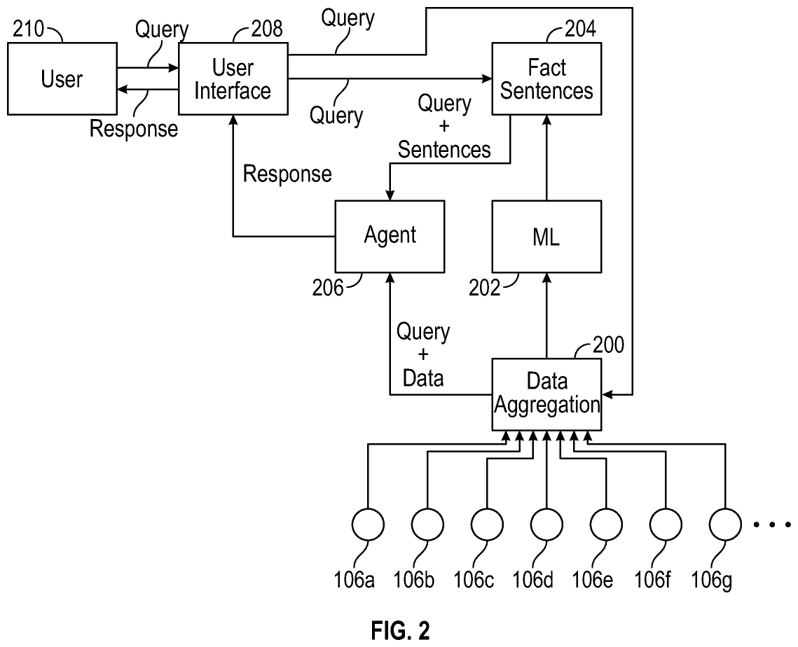

FIG. 2 is a block diagram conceptually illustrating exemplary operation of the system of FIG. 1 in accordance with embodiments of the disclosure. Blocks of FIG. 2 conceptually illustrate one or more computer-implemented programs or modules executed on any one or more of the above-described computing devices of FIG. 1, as well as their operation. Here, a data aggregation module 200 implemented on controller 104 receives and conditions data output by sensors 106a-g, as well as any other desired data such as data describing any aspect of manufacturing facility 102, e.g., layouts of production lines 114, 116, any environmental states of any portion of the manufacturing facility 102, or the like. Data aggregation module 200 may also accept queries from user interface 208, further described below, and return any received queries along with responsive data to agent 206. In this manner, embodiments of the disclosure allow users to submit queries that return both data from sensors 106a-g and fact sentences synthesizing sensor data.

A machine learning (ML) module 202 then converts the data output from data aggregation module 200 into any desired quantities. In some embodiments of the disclosure, module 202 converts this data to performance metrics, or any quantities of interest to operators of manufacturing facility 102. Performance metrics may be any quantities desired which characterize any aspect of manufacturing facility 102 or any products 110x it produces, such as speed or uptime of any one or more lines 114, 116, any properties of products 110x such as material properties of produced products (e.g., product elasticity, dimensions, water content, etc.), as well as defects in products 110x or any statistics related thereto such as defect rates or characterizations thereof, or the like.

In some embodiments of the disclosure, model 202 also determines any desired quantities of interest which may be correlated to any performance metrics. For example, model 202 may not only determine material properties of products 110x, but also predictors of these properties. In some embodiments, predictors may be any variables represented by outputs of sensors 106a-g, or any quantities derived therefrom, which have some correlation with any one or more performance metrics. As one example, model 202 may determine that a detected quantity or physical state of an input material to a line 114, 116 may be correlated with a material property of interest of a product 110x, e.g., the quantity or temperature of water added to the mixture of a bread production line may be correlated to a determined performance metric such as the measured elasticity of the resulting bread dough. Correlations may be any associations with any performance metric, and may be positive or negative correlations. Embodiments of the disclosure contemplate determination of any types of correlations in any known manner, as well as determination of causal relationships between any predictors and performance metrics where possible. In some embodiments, model 202 may also determine trends in any performance metrics, detected or calculated quantities, or correlations, e.g., by storing values of these in storage 124 and analysis of past and current stored values. Model 202 may also compare values to stored thresholds or other criteria, to report values that exceed any predetermined bounds, and thereby generate notifications, alerts, warnings, or the like.

Module 202 may employ any methods, processes, mathematical or analytical models, or the like, to determine any desired performance metrics from input data, as well as any predictors thereof and any correlations or causal relationships with any performance metrics. In some embodiments of the disclosure, module 202 can implement any one or more machine learning or other models trained to receive data such as sensor 106a-g data as input, and to generate any desired performance metrics as output. In some embodiments of the disclosure, module 202 can also implement any one or more machine learning or other models trained to receive these performance metrics and data such as sensor 106a-g data as inputs, and to determine any correlations therebetween. In some embodiments, these models may include any regression models such as random forest models, K nearest neighbor models, clustering models, support vector machines, or the like. Models may also include any clustering models such as K-means models, gaussian mixture models, agglomerative hierarchy models, or the like. Any one or more models of any type are contemplated.

In some embodiments, module 202 may also determine the presence of anomalies or anomalous behavior in received data. Anomalous behavior in any input data or determined performance metrics may be detected in various manners, such as by comparison of any such variables to one or more predetermined metrics. For instance, an anomaly may be flagged when any variable of interest, such as dough temperature, ambient temperature, or reject numbers exceed any predetermined amounts. Module 202 may then determine correlations between the variable exhibiting anomalous behavior and any other variables or performance metrics, as described above.

A fact sentences module 204 may then generate natural language text, such as grammatically complete natural language text-based sentences, summarizing any performance metrics, predictors and/or trends thereof, and any determined correlations and notifications/alerts/warnings which are output by ML module 202. In this manner, generated fact sentences do not merely present data, but also provide analysis and context for relevant data, which may assist agent 206 in providing more accurate and complete responses to queries from user interface 208. As one example, when the manufacturing facility 102 is a bread production facility, fact sentences module 204 may receive output from ML module 202 that includes values of dough elasticity, values of variables such as input water temperature, facility conditions such as the time at which water temperature measurements were taken, and the like. An exemplary sentence output by module 204 may then be a grammatically complete natural language text sentence such as “At 8:34 am today, the dough elasticity index measured on line 1 was 0.41.” A further exemplary sentence may be “At 8:34 am today, the temperature of the water added to the dough of line 1 was 17.2° C.” Another exemplary sentence may be “Today, the correlation coefficient between dough elasticity and input water temperature at line 1 was 0.45.” Further exemplary sentences may be generated in response to anomaly detection, and include a description of the anomaly, when it occurred, and its determined cause(s), i.e., predictors exhibiting a sufficiently high correlation to the variable exhibiting an anomaly. One example may be “At 2:23 pm today, dough temperature of line 2 exceeded 20.5° C. Dough temperature of line 2 is positively associated with outside air temperature, and the temperature of the water added to the dough of line 2.”

In some embodiments of the disclosure, module 204 may employ any NLP methods and/or models to generate natural language text summarizing specified data. Such methods and models are known. Fact sentences may be formed, for example, using a name assigned to a variable of interest, a stored description of the variable, the relevant time index, and the measured value of the variable at the time index.

Generated fact sentences may be stored for later use in a memory such as database 124. Fact sentences may be stored in various manners. In some embodiments, each fact sentence may be stored in one column of a unique row. Metadata of the sentence may also be stored in other columns of the same row, and may include any data associated with the sentence, including the data, variables, and values listed in the sentence, any data used to derive any quantity listed in the sentence, any data collected at the same time index, and the like. Embeddings, or associated vectors of data input to neural networks or other artificial intelligence or machine learning modules of the module 202, corresponding to the fact sentence, may also be stored in a separate column. In this manner, system 100 may more readily retrieve and return responses to queries for such metadata and embeddings.

A user interface 208 may be generated to accept user queries regarding aspects of manufacturing facility 102. User interface 208 may be generated by any computing device, for example, user interface 208 may be centrally generated by data synthesis server 122 for multiple users 126, or may be locally generated by each user computer 126.

In some embodiments, data synthesis server 122 may execute data aggregation module 200, ML module 202, and fact sentences module 204 in addition to user interface 208. Server 122 may thus transmit received queries along with natural language text output from fact sentences module 204, to a computer-based agent 206 such as a chatbot. Agent 206 may be any computer-based service capable of generating natural language responses to natural language queries. In some embodiments, agent 206 is a chatbot employing one or more large language models, such as the ChatGPT™ service made available by OpenAI Inc., or the like.

Agent 206 may be configured to receive a natural language query and natural language input data, interpret the meaning of the input query as requesting information regarding the input data, and generate a corresponding response using the input data. In some embodiments, agent 206 may include an application programming interface (API) for specifying input of the natural language text output by fact sentences module 204 as well queries from user interface 208. Accordingly, agent 206 may generate responses to the queries from user interface 208, and return these responses to user interface 208 for display to the user. In this manner, users may not only request information on manufacturing facility 102, but also may receive answers to their queries in convenient and easy-to-read natural language form. Further, it may be noted that some agents 206 exhibit improved performance when their input data is in natural language form rather than in another format such as, e.g., one in which mathematical operations are required in order to interpret the input data. Accordingly, embodiments of the disclosure effectively translate manufacturing data into a natural language format, thus allowing for increased accuracy in agent 206 responses to queries.

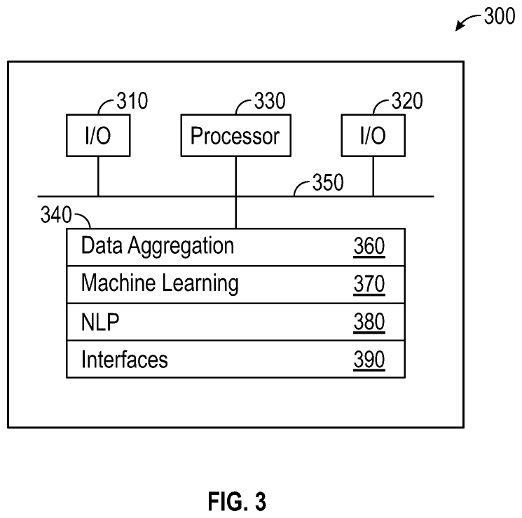

FIG. 3 is a generalized embodiment of an illustrative data synthesis computing device constructed for use according to embodiments of the disclosure. Here, device 300 may be an embodiment of a data synthesis server 122, and in some embodiments may implement manufacturing site data synthesis and interface processes described herein. Device 300 may receive content and data via I/O units 310 and 320. I/O unit 310 may receive sensor measurements from sensors 106a-g and may transmit instructions thereto for, e.g., entering/exiting sleep/active modes as desired. I/O unit 320 may provide data to, and receive content from, one or more databases 124. Device 300 has a processor 330 or processing circuitry, and storage 340. The processor 330 and storage 340, along with I/O units 310 and 320, are in electronic communication with each other via a communications medium 350 such as a bus.

Storage 340 is a memory that stores a number of modules or sets of instructions for execution by processing circuitry 330. In particular, storage 340 may store one or more data aggregation module 360, an analytics & ML module 370, an NLP module 380, and interfaces 380. The data aggregation module 360 includes one or more programs for conditioning and formatting data received from sensors 106a or any other desired sources, and storing it in a memory of device 300 or in database 124. Analytics & ML module 370 includes one or more programs for synthesizing the data output by aggregation module 360, such as determining values of any desired performance metrics and/or variables, and determining correlations among the various performance metrics and variables. In some embodiments, module 370 may include instructions for executing one or more machine learning models trained to determine values of performance metrics and variables, as well as correlations therebetween. NLP module 380 includes one or more programs for formatting the performance metrics, variables, and correlations output by ML module 370 into natural language text, while interfaces module 390 includes code for generating user interface 208 allowing users to enter queries and view corresponding replies generated by agent 206.

One of ordinary skill in the art will appreciate that each of these modules 360-390 may reside on, and be executed by, any suitable electronic computing device or devices. For example, user interface programs 390 may reside on and be executed by device 300 as shown, or may reside on and be executed by devices of individual users, instead.

The device 300 may be any electronic device capable of performing manufacturing site data synthesis and interface operations described herein. For example, the device 300 may be a server computer located proximate to the manufacturing facility 102. Alternatively, the device 300 may be a remote device such as a cloud server. The device 300 may alternatively be a laptop computer or desktop computer configured as above.

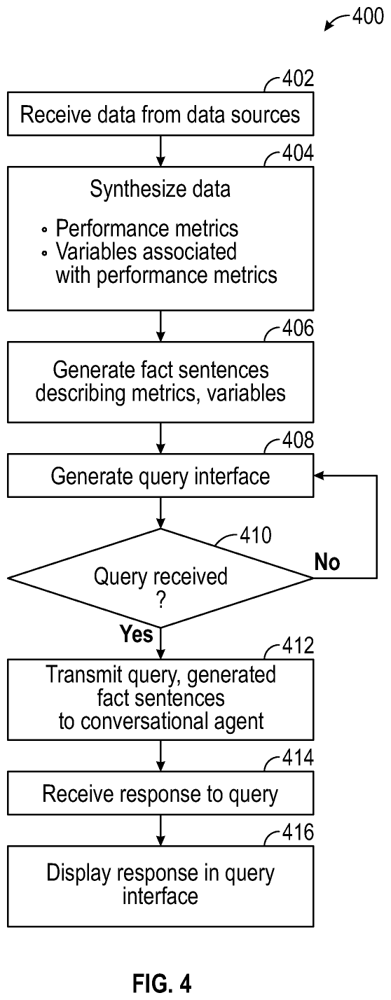

FIG. 4 is a flow chart depicting an exemplary method 400 of implementing a natural language interface for monitoring of manufacturing processes in accordance with embodiments of the disclosure. Initially, at step 402, data synthesis server 122 (i.e., device 300) may receive data from data sources such as sensors 106a-g and/or any other desired manufacturing facility 102 data. This step 402 includes any desired conditioning and/or formatting of the data as performed by and described in connection with data aggregation module 360. Next, at step 404, ML module 370 synthesizes the formatted/conditioned data to calculate any desired performance metrics and variables associated therewith, as well as any correlations therebetween. For example, data may include variables such as line speeds detected by sensors 106a-g placed on lines 114, 116, from which performance metrics such as line uptime may be determined. Correlations between these two, as well as between uptime and any other desired variables, may also be calculated as desired. In some embodiments, ML module 370 generates an identifier of the data from which the performance metrics/variables/correlations were generated. The identifier may be any identifiers or identification numbers capable of identifying the data used in generating any particular performance metrics/variables/correlations.

Next, at step 406, NLP module 380 generates text describing these metrics and variables, as well as their determined correlations if any. More specifically, NLP module 380 generates text summarizing these metrics, variables, and correlations in a natural language format. As above, generated text may take the form of grammatically complete, natural language textual sentences describing current values of the metrics, variables, and correlations. Embodiments of the disclosure contemplate translation of current values of the metrics, variables, and correlations into any form or format compatible with any desired computer-based agent.

Subsequently, at step 408, interface module 390 may generate a user interface for users such as a user operating user computer 126 to enter queries concerning manufacturing facility 102, and to view responses to these queries. Once a query is received at step 410, the process proceeds to step 412 where data synthesis server 122 transmits it, along with the natural language text generated at step 406, to agent 120 for calculation of a response to the query. In some embodiments, the corresponding identifier generated by ML module 370 at step 404 is also transmitted to agent 120, along with a request for the agent 120 to return the identifier corresponding to the performance metrics/variables/correlations used in any response to the query. Once a response or answer to the query is received at step 414, it is displayed by interface module 390 on the user interface at step 416, for display or presentation to the user.

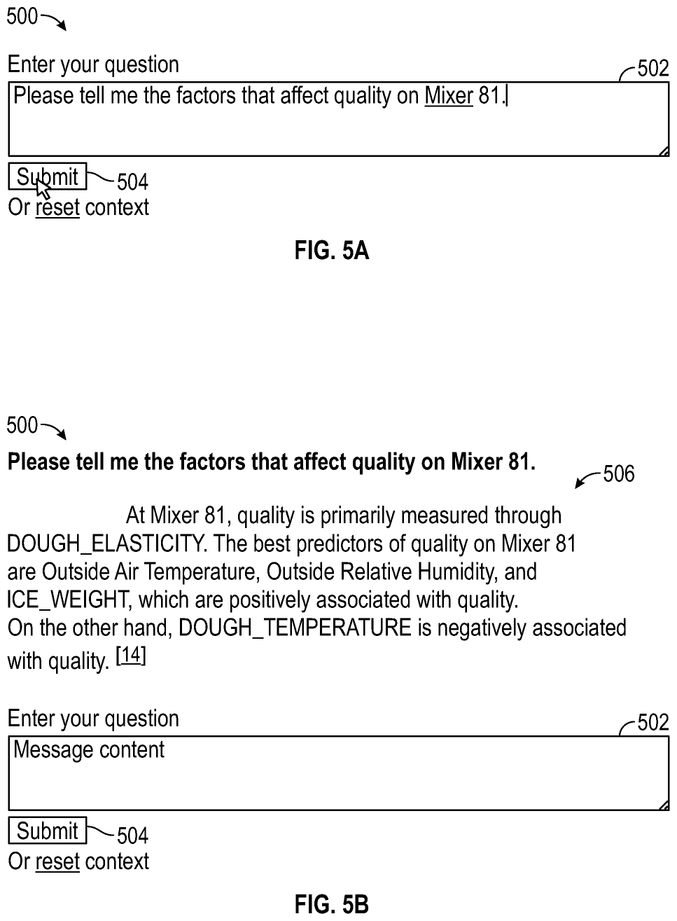

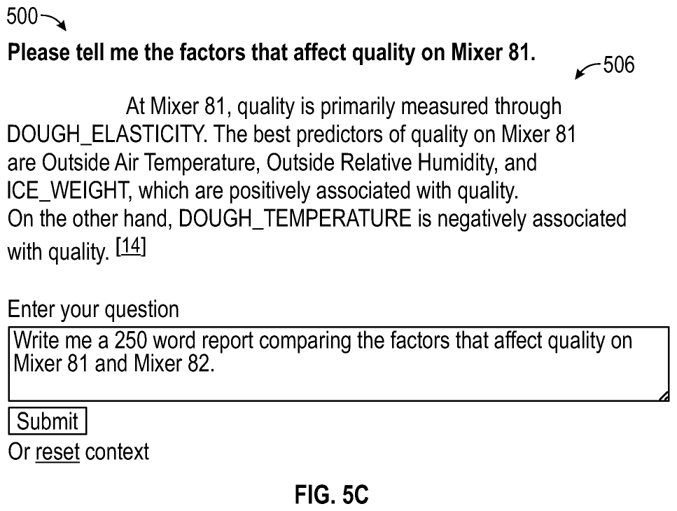

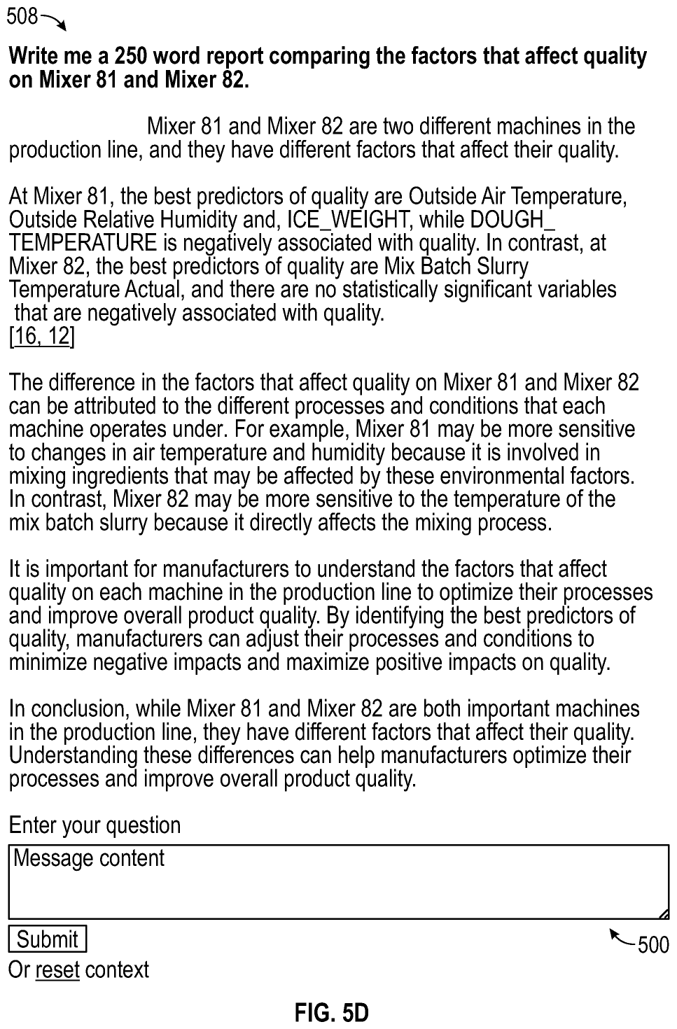

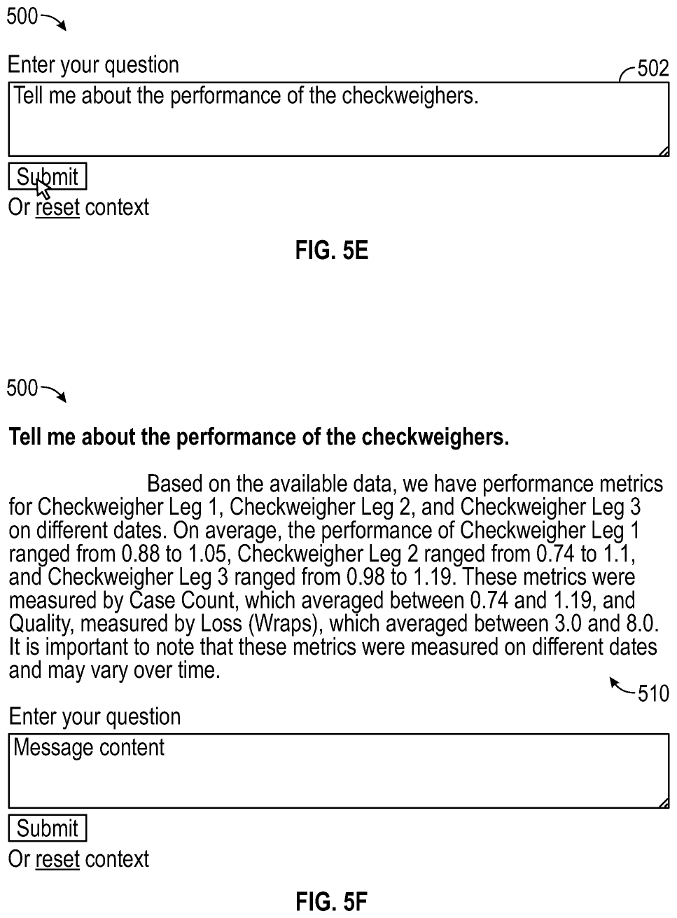

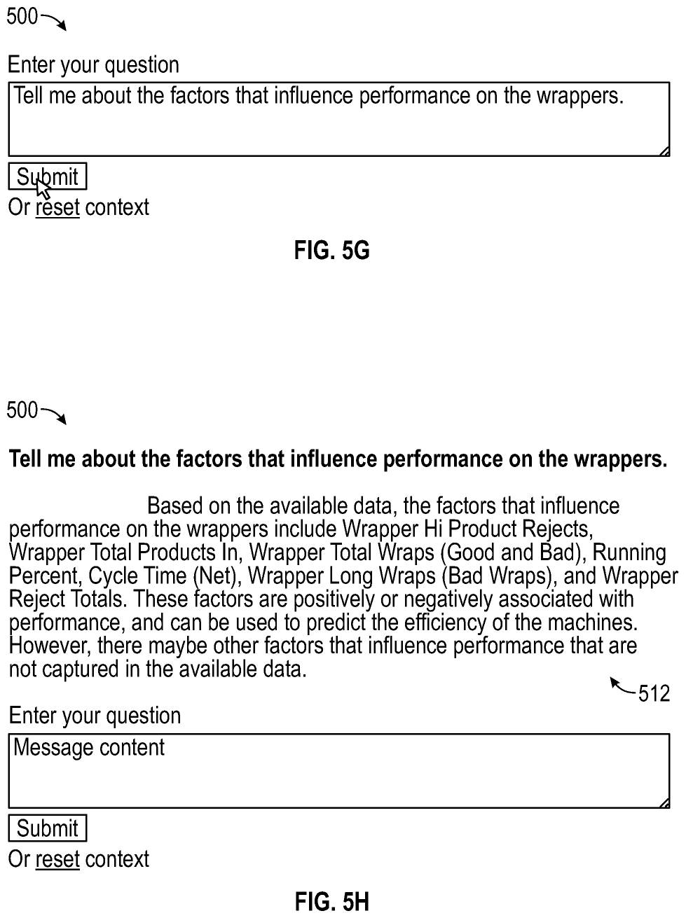

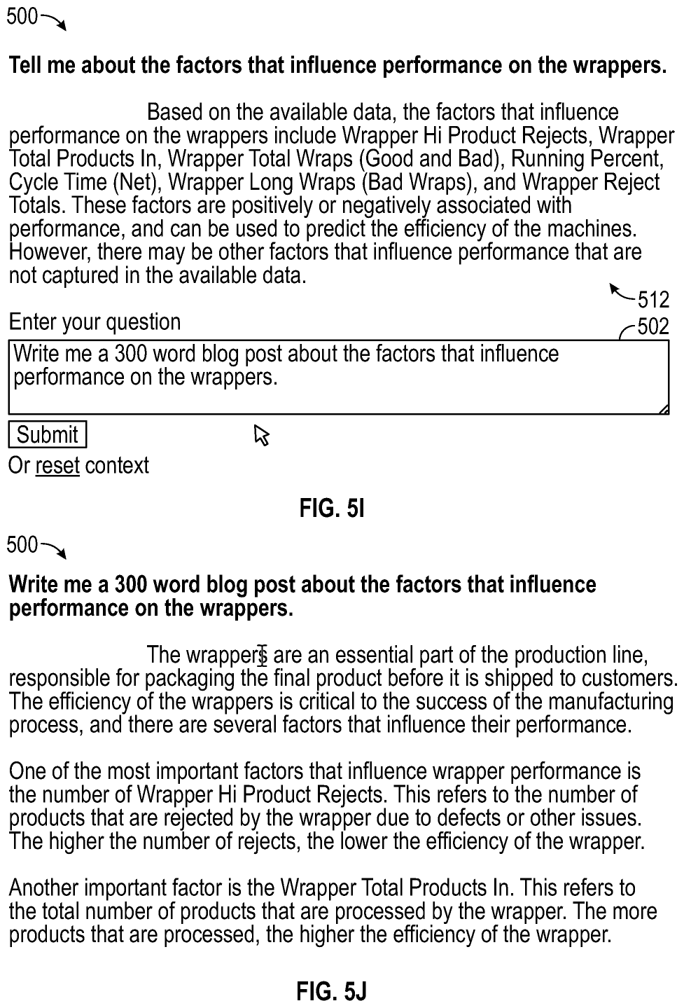

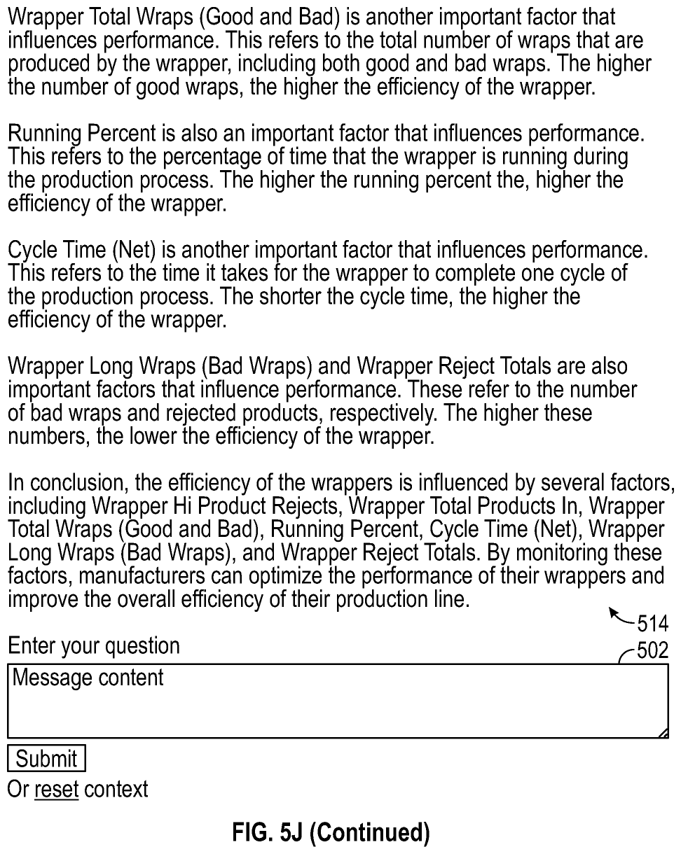

FIGS. 5A-5J illustrate exemplary user interfaces and their use in accordance with embodiments of the disclosure. FIGS. 5A-5J illustrate exemplary user interfaces used in connection with a bakery facility. In FIGS. 5A-5B, a user interface 500 includes a text window 502 and a submit button 504. Users can enter a query in window 502 in natural language form and send it to the data synthesis server 122 by selecting the submit button 504. In FIG. 5A, a user has elected to enter the natural language query “Please tell me the factors that affect quality on Mixer #1,” where Mixer #1 is a mixing machine operating within the bakery facility. Selecting submit button 504 submits the query, along with the natural language data summary produced by NLP module 380 and optionally any relevant identifiers produced by ML module 370, to agent 120. Agent 120 in turn produces the query response 506, which may be displayed proximate to the query window 502. Although it is shown in FIG. 5B above query window 502, response 506 may be displayed at any location and in any format within user interface 500.

Here, the query of FIG. 5A requests factors that affect quality of Mixer #1. Agent 120 accordingly parses its received natural language data summary and selects the metric most closely corresponding to quality, in this case DOUGH_ELASTICITY, and identifies this metric within response 506 as being the metric primarily measuring quality. Agent 120 also selects those variables having the greatest correlation values with this metric (in this case, Outside Air Temperature, Outside Relative Humidity, and ICE_WEIGHT which is a measure of the amount of ice added to the dough), displaying them in natural language sentences as being the predictors most positively associated with the quality metric. Similarly, agent 120 selects the variable (DOUGH_TEMPERATURE) most negatively associated with the quality metric and identifies it as such in a natural language sentence. These natural language sentences are received from agent 120 and displayed as response 506 at a suitable location within user interface 500.

Embodiments of the disclosure may utilize capabilities of agent 120 besides the ability to retrieve information responsive to a query. For example, agent 120 may be able to generate longer form text responses formatted in desired ways, such as reports, papers, blog posts, and the like. FIGS. 5C-5D illustrate a further query entered in query window 502 after results 506 are displayed, and the corresponding response. Subsequent to display of results 506, another query is entered requesting a 250 word report comparing the factors that affect quality on two different mixers, 81 and 82. Here, agent 120 determines the metric, variables, and correlations of FIG. 5B for mixer 82 in addition to those previously identified for mixer 81, and return them in a more extensive natural language report form. In particular, a natural language explanation is generated describing the identified variables and their correlations to dough elasticity metrics.

FIGS. 5E-5F illustrate a more open-ended query entered into window 502, and the corresponding reply. Here, entered query simply states, “Tell me about the performance of the checkweighers.” In response, agent 120 selects the performance metrics described by the natural language data and lists them in response 510 along with a description of each metric and their available values.

FIGS. 5G-5H illustrate a similar open-ended query entered into window 502, requesting in general manner factors that influence performance on wrapping machines. In response, agent 120 selects each variable having a correlation with a performance variable (or determined performance metric) as shown by the natural language data. These variables are then listed in response 512. It is noted that the query of FIGS. 5E-5F requests performance of a machine, while the query of FIGS. 5G-5H only requests the factors that influence performance. Embodiments of the disclosure are able to determine the differing intents of each query and return intent-specific results. Thus, for example, while the response 510 of FIG. 5F lists numerical values of performance metrics which appear in the data to describe performance more accurately, response 512 only lists the relevant variables and the nature of their correlations to performance.

FIGS. 51-5J illustrate a further query entered into window 502, requesting a 300—word blog post about the factors that influence performance on the wrappers, i.e., a subsequent and more detailed version of response 512. In reply, agent 120 generates a response 514 containing the information of response 512 in blog post form, adding further description of the variables and relevant background information. Here, background information may be found within the natural language data and/or from other information sources, e.g., via search engine, previously stored information on manufacturing facility 102, or the like.

The foregoing description, for purposes of explanation, used specific nomenclature to provide a thorough understanding of the disclosure. However, it will be apparent to one skilled in the art that the specific details are not required to practice the methods and systems of the disclosure. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, any performance metrics and variables may be determined from sensor or other input data, in any manner. Further, these metrics and variables, and their correlations, may be represented in any form compatible with a chatbot or other computer-based agent. The embodiments were chosen and described in order to best explain the principles of the invention and its practical applications, to thereby enable others skilled in the art to best utilize the methods and systems of the disclosure and various embodiments with various modifications as are suited to the particular use contemplated. Additionally, different features of the various embodiments, disclosed or otherwise, can be mixed and matched or otherwise combined so as to create further embodiments contemplated by the disclosure.

What is claimed is:

1. A computer-implemented method for monitoring manufacturing, the method comprising:
receiving data output by data sources of a manufacturing site;
determining, from the received data, one or more predictors having correlations with one or more performance metrics characterizing a process carried out at the manufacturing site;
generating one or more textual sentences describing the one or more predictors and the corresponding correlations;
generating a computer-based interface for receiving a query requesting information describing the manufacturing site;
receiving the query;
in response to receiving the query, transmitting the query and the generated one or more textual sentences to a conversational agent;
receiving, from the conversational agent, a response to the transmitted query; and
displaying the response on the computer-based interface.

2. The computer-implemented method of claim 1, wherein the data sources include one or more sensors monitoring the process carried out at the manufacturing site, and wherein the data includes output of the one or more sensors.

3. The computer-implemented method of claim 1, wherein the determining further comprises determining the one or more predictors according to at least one machine learning model having the received data as input and trained to generate the one or more predictors as output.

4. The computer-implemented method of claim 1, wherein the conversational agent comprises a chatbot generating the response at least in part according to a large language model.

5. The computer-implemented method of claim 1, wherein the query is a natural language query, and wherein the response is a natural language response.

6. The computer-implemented method of claim 1, wherein the predictors include one or more of a physical state associated with the process, or an environmental state of the manufacturing site.

7. The computer-implemented method of claim 1, wherein the correlations include positive correlations between the one or more predictors and the one or more performance metrics, and negative correlations between the one or more predictors and the one or more performance metrics.

8. The computer-implemented method of claim 1, wherein the predictors comprise one or more of the output of the data sources or a quantity determined from the output of the data sources.

9. The computer-implemented method of claim 1, wherein the performance metrics comprise one or more of the output of the data sources or a quantity determined from the output of the data sources.

10. The computer-implemented method of claim 1, further comprising storing the received data to a memory and generating an identifier of the stored data, wherein the transmitting the query further comprises transmitting the identifier and a request to include a reference to the identifier in the response to the transmitted query.

11. The computer-implemented method of claim 1:
further comprising determining a trend in values of any one or more of the one or more predictors, the correlations, or the one or more performance metrics;
wherein the generated text further describes the determined trend.

12. The computer-implemented method of claim 1:
further comprising determining whether values of any one or more of the one or more predictors, the correlations, or the one or more performance metrics exceed one or more corresponding predetermined thresholds;
wherein the generated text further describes the one or more predictors, the correlations, or the one or more performance metrics exceeding the corresponding one or more predetermined thresholds.

13. The computer-implemented method of claim 1, wherein the determining further comprises:
determining the one or more predictors from the received data;
determining the one or more performance metrics at least in part from the received data; and
determining the correlations, the correlations being relationships between the determined one or more predictors and the determined one or more performance metrics.

14. The computer-implemented method of claim 13, further comprising:
determining an occurrence of an anomalous event in one or more of the received data, the one or more predictors, or the one or more performance metrics;
predicting a causal relationship between the one or more correlations and the anomalous event.

15. The computer-implemented method of claim 1, wherein the transmitting the query further comprises, in response to receiving the query, transmitting the query, the generated one or more textual sentences, and at least a portion of the received data to the conversational agent.

16. The computer-implemented method of claim 1, wherein the textual sentences are grammatically complete sentences.

17. An electronic device, comprising:
one or more processors;
a memory; and
one or more programs, wherein the one or more programs are stored in the memory and configured to be executed by the one or more processors, the one or more programs including instructions for:
receiving data output by data sources of a manufacturing site;
determining, from the received data, one or more predictors having correlations with one or more performance metrics characterizing a process carried out at the manufacturing site;
generating one or more textual sentences describing the one or more predictors and the corresponding correlations;
generating a computer-based interface for receiving a query requesting information describing the manufacturing site;
receiving the query;
in response to receiving the query, transmitting the query and the generated one or more textual sentences to a conversational agent;
receiving, from the conversational agent, a response to the transmitted query; and
displaying the response on the computer-based interface.

18. The electronic device of claim 17, wherein the textual sentences are grammatically complete sentences.

19. A non-transitory computer-readable storage medium storing one or more programs, the one or more programs comprising instructions, which when executed by one or more processors of an electronic device, cause the electronic device to:
receive data output by data sources of a manufacturing site;
determine, from the received data, one or more predictors having correlations with one or more performance metrics characterizing a process carried out at the manufacturing site;
generate one or more textual sentences describing the one or more predictors and the corresponding correlations;
generate a computer-based interface for receiving a query requesting information describing the manufacturing site;
receive the query;
in response to receiving the query, transmit the query and the generated one or more textual sentences to a conversational agent;
receive, from the conversational agent, a response to the transmitted query; and
display the response on the computer-based interface.

20. The non-transitory computer-readable storage medium of claim 19, wherein the textual sentences are grammatically complete sentences.
